(19) United States
(12) Patent Application Publication
(10) Pub. No.: US 2017/0192558 A1
(43) Pub. Date: Jul. 6, 2017

(54) ARRAY SUBSTRATE, TOUCH DISPLAY PANEL AND TOUCH DISPLAY DEVICE

(71) Applicants: Shanghai AVIC OPTO Electronics Co., Ltd., Shanghai (CN); Tiamma Micro-Electronics Co., Ltd., Shenzhen (CN)

(72) Inventors: Kerui Xi, Shanghai (CN); Tingting Cui, Shanghai (CN); Zhengfang Xie, Shanghai (CN)

(21) Appl. No.: 15/159,826

(22) Filed: May 20, 2016

(30) Foreign Application Priority Data
Dec. 31, 2015 (CN) 201511027131.X

(51) Int. Cl. G06F 3/044; G06F 3/041

(52) U.S. Cl. CPC G06F 3/044; G06F 3/0412

(57) ABSTRACT

The present disclosure discloses an array substrate, touch display panel and touch display device. The array substrate comprises a substrate, a display region and a non-display region surrounding the display region. A driver chip is provided in the non-display region. The display region comprises a plurality of data lines. Each of the plurality of data lines is electrically connected to the driver chip via a respective one of a plurality of first connection lines; and a plurality of touch electrode blocks. The plurality of touch electrode blocks are electrically connected to the driver chip via a plurality of touch signal lines. In the non-display region, the plurality of touch signal lines are not overlapped with the plurality of first connection lines in a direction perpendicular to the substrate.

### CROSS-REFERENCES TO RELATED APPLICATIONS

This application claims priority to a Chinese patent application No. 201511027131.X filed on Dec. 31, 2015 and entitled “Array Substrate, Touch Display Panel and Touch Display Device”, the disclosure of which is incorporated herein by reference in its entirety.

### TECHNICAL FIELD

The present disclosure relates to the field of display technology, in particular to an array substrate, a touch panel display and a touch display device.

### TECHNICAL BACKGROUND

With the rapid development of display technology, the touch screen has been populated in people lives. Compared to a conventional display device which only provides the display function, the display device using the touch screen enables the user to make information interaction with the display control host. The display device with a touch function not only can perform a display function, but also can perform a controlled function by touch operation.

Currently the display device having a touch function is mainly divided into an on-cell type and an in-cell type. The in-cell touch display device attracts much attention due to its relatively light weight and thin advantages. In the array substrate of the existing in-cell touch display device, a touch signal line is required for each of touch electrode blocks. As the size of the product increases, a greater number of touch signal wirings are required. Also, since the touch signal lines and data lines are overlapped with each other in the direction perpendicular to the substrate, a capacitance between the touch signal lines and the data lines would be increased, thus causing the problem of generating electrostatic discharge and open circuit or short circuit due to the release of the electrostatic discharge, etc.

### SUMMARY

Embodiments of the present disclosure provide an array substrate, a touch panel display and a touch display device, in order to prevent the data lines from being interfered by the touch signal lines due to the increased capacitance between the touch signal lines and the data lines. To this end, the present disclosure employs the following technical solution:

In a first aspect, embodiments provide an array substrate comprising a substrate, a display region and a non-display region surrounding the display region. A driver chip is provided in the non-display region. The display region comprises a plurality of data lines, wherein each of the plurality of data lines is electrically connected to the driver chip via a respective one of a plurality of first connection lines; and a plurality of touch electrode blocks, wherein the plurality of touch electrode blocks are electrically connected to the driver chip via a plurality of touch signal lines. In the non-display region, the plurality of touch signal lines are not overlapped with the plurality of first connection lines in a direction perpendicular to the substrate.

In a second aspect, embodiments provide a touch display panel, including an array substrate provided by the first aspect.

In a third aspect, embodiments provide a touch display device, including a touch display panel provided by the second aspect.

For the array substrate, the touch panel display and the touch display device provided by the embodiments, a driver chip and the plurality of first connection lines are provided in the non-display region of the array substrate. The display region of the array substrate comprises a plurality of data lines. The plurality of data lines are connected to the driver chip via a plurality of first connection lines. A plurality of touch electrode blocks, the plurality of touch electrode blocks are electrically connected to the driver chip via a plurality of touch signal lines. In the non-display region, the plurality of touch signal lines are not overlapped with the plurality of first connection lines in a direction perpendicular to the substrate, so that the capacitance between the touch signal lines and the first connection lines is decreased, thus reducing the possibilities of the generation of electrostatic discharge and the open or short circuit due to the release of electrostatic discharge.

### DESCRIPTION OF DRAWINGS

Other features, objects and advantages of the present disclosure will become more apparent by illustrating the embodiments of the present disclosure in detail below with reference to the accompanying drawings, wherein

FIG. 1 is a schematic plan view showing an embodiment of a structure of the array substrate according to an embodiment of the present disclosure;

FIG. 2 is a sectional view shown in FIG. 1 along a line A-A′;

FIG. 3 is a schematic top view showing a structure of an array substrate according to another embodiment of the present disclosure;

FIG. 4 is a schematic top view showing a structure of the array substrate according to another embodiment of the present disclosure;

FIG. 5 is a schematic top view showing a touch electrode block in FIG. 4;

FIG. 6 is a schematic top view showing a structure of an array substrate according to another embodiment of the present disclosure;

FIG. 7 is a schematic top view showing a structure of an array substrate according to another embodiment of the present disclosure;

FIG. 8 is a schematic circuitry view of the switching circuit in FIG. 7; and

FIG. 9 is a schematic top view showing a structure of an array substrate according to another embodiment of the present disclosure.

### DETAILED DESCRIPTION

Below in conjunction with the accompanying drawings and the embodiment of the present disclosure will be further described in detail. To be understood that the specific embodiments described herein merely illustrate the disclosure and not limiting of the present invention. It also is noted that, for ease of description, the drawings illustrate only with the present disclosure is related to some but not all content.

An embodiment of the present disclosure provides an array substrate.

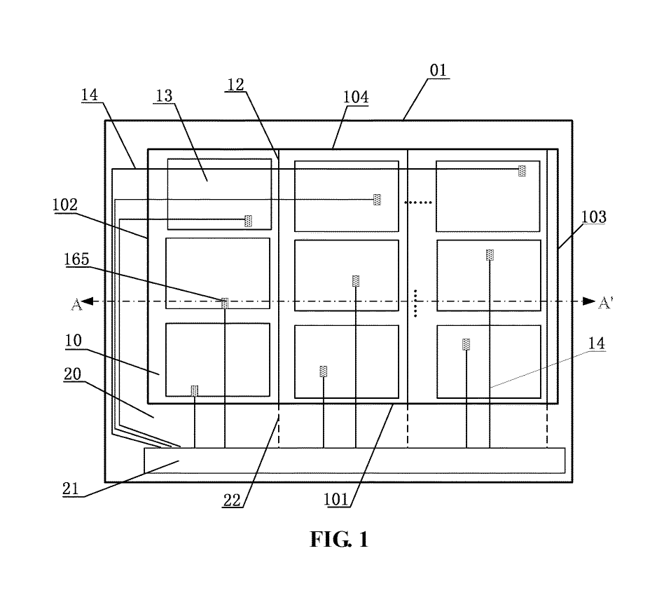

FIG. 1 is a schematic plan view showing an embodiment of a structure of an array substrate according to an embodiment of the present disclosure. As shown in FIG. 1, the array substrate comprises: a substrate 01; a display region 10 and a non-display region 20 surrounding the display region 10, the non-display region 20 is provided with a driver chip 21. The display region 10 includes: a plurality of data lines 12, and each of the plurality of data lines 12 is electrically connected to the driver chip via a respective one of a plurality of first connection lines. A plurality of touch electrode blocks 13 which are electrically connected to the driver chip 21 via a plurality of touch signal lines 14. In the non-display region 20, the plurality of touch signal lines 14 are not overlapped with the plurality of first connection lines 22 in a direction perpendicular to the substrate 01. The display region 10 refers to a region in which displaying pixels are provided on the substrate 01. The display region 10 generally has rectangular region of which two opposite sides from the four sides may be defined as the first side 101 and the fourth side 104 of the display region 10, respectively, and the other two opposite sides from the four sides may be defined as the second side 102 and the third side 103 of the display region 10, respectively. The driver chip 21 refers to a chip which is configured to provide data signals and touch signals, and the driver chip 21 is provided at the external of a first side 101 of the display region 10 (i.e. the driver chip 21 is provided in a first non-display region corresponding to a first side 101 of the display region 10). It is noted that, FIG. 1 only illustratively shows each of the touch electrode blocks 13 corresponds to one of the touch signal lines 14. However, it should be understood that the present embodiment is not limited thereto. Alternatively, each of the touch electrode blocks 13 may be configured to correspond to the plurality of touch signal lines 14.

In the array substrate of the present embodiment, in the non-display region, the plurality of touch signal lines 14 are not overlapped with the plurality of first connection lines 22 in a direction perpendicular to the substrate, so that the capacitance between the touch signal lines 14 and the first signal lines 22 is decreased, thus reducing the possibilities of generation of the electrostatic discharge and the open or short circuit due to release of the electrostatic discharge.

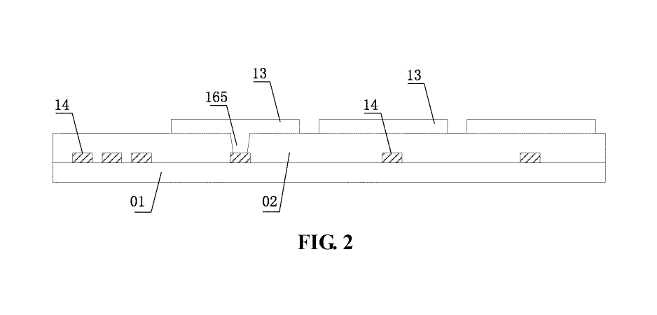

FIG. 2 is a sectional view shown in FIG. 1 along a cut line A-A′. In combination with FIGS. 1 and 2, a common electrode layer (not shown) is provided on the substrate 01. The common electrode layer comprises a plurality of electrodes blocks insulated from each other, each of the electrode blocks is connected to the driver chip via a common signal line, and the electrode blocks are uniformly arranged in an matrix pattern. The electrode blocks are multiplexed as the touch electrode blocks 13, the common signal lines are multiplexed as the touch signal lines 14, and each of the touch electrode blocks 13 is electrically connected to the corresponding touch signal lines 14 through a via hole 165 in the insulating layer 02. The structure can be made in a relatively simple and low cost ways.

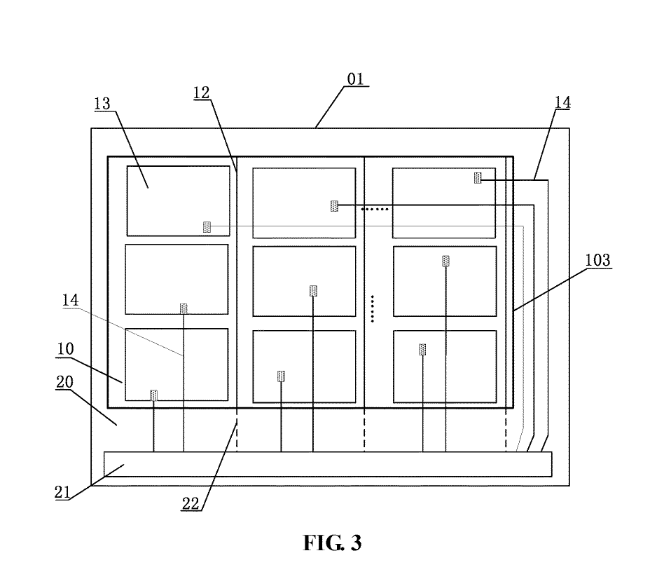

Illustratively, at least one of the touch signal lines 14 is extended from the driver chip 21 to the external of the second side 102 of the display region 10 (i.e. at least one of the touch signal lines 14 is extended from the driver chip 21 to a second non-display region corresponding to a second side 102 of the display region 10)(refer to FIG. 1), or, at least one of the touch signal lines 14 is extended from the driver chip 21 to the external of the third side 103 of the display region 10 (i.e. at least one of the touch signal lines 14 is extended from the driver chip 21 to a third non-display region corresponding to a third side 103 of the display region 10)(refer to FIG. 3), so as to be electrically connected to at least one of the touch electrode blocks 13 in the display region 10. In such an arrangement, the touch signal lines 14, which are extended to the external of the second side 102 of the display region 10 or the external of the third side 103 of the display region 10 (i.e. which are extended to the second non-display region of the display region 10 or the third non-display region of the display region 10), are not overlapped with the first connection lines 22 in a direction perpendicular to the substrate 01, thus preventing the first connection lines 22 from being interfered by the touch signal lines 14, which are extended to the external of the second side 102 of the display region 10 or the external of the third side 103 of the display region 10 (i.e. which are extended to the second non-display region of the display region 10 or the third non-display region of the display region 10) due to the increased capacitance between the touch signal lines 14 and the first connection lines 22.

In the embodiment of the present disclosure, a row direction refers to the direction of extending from the second side 102 to the third side 103 of the display region 10, or the direction of extending from the third side 103 to the second side 102 of the display region 10. A column direction refers to the direction of extending from the first side 101 to the fourth side 104 of the display region 10, or the direction of extending from the first side 101 to the fourth side 104 of the display region 10. The column direction and the row direction are perpendicular to each other.

It is noted that the same parts refers to the same reference numerals throughout Figures, and the same parts in the following embodiments with the above embodiment of FIG. 1 are not discussed again.

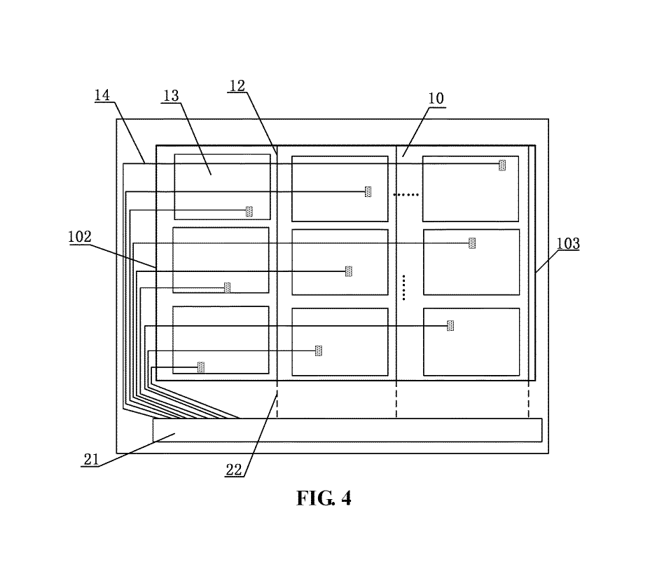

Illustratively, as shown in FIG. 4, each of the touch signal lines 14 may be extended from the driver chip 21 to the external of the second side 102 of the display region 10 (i.e. each of the touch signal lines 14 may be extended from the driver chip 21 to the second non-display region of the display region 10). In such an arrangement, each of the touch signal lines 14 is not overlapped with the first connecting lines 22 in the direction perpendicular to the substrate 01, thus preventing the first connection lines 22 from being interfered by the touch signal lines 14 due to the increased capacitance between the touch signal lines 14 and the first connection lines 22. It is noted that each of the touch signal lines 14 may also be extended from the driver chip 21 to the external of the third side 103 of the display region 10 (i.e. to the third non-display region of the display region 10), and such arrangement can also prevent the first connecting lines 22 from being interfered by the touch signal lines 14, which is not described again here.

Illustratively, with reference to FIG. 4, the plurality of touch signal lines 14 may be directly electrically connected to the corresponding touch electrode block 13 of the display region 10 at the external of the second side 102 of the display region 10 (i.e. in the second non-display region of the display region 10). Such arrangement can prevent the first connection lines 22 from being interfered by the touch signal lines 14 due to the increased capacitance between the touch signal lines 14 and the first connection lines 22. It is noted that, in the case that each of the touch signal lines 14 is extended from the driver chip 21 to the external of the third side 103 of the display region 10 (i.e. in the third non-display region of the display region 10), the plurality of touch signal lines 14 may be directly electrically connected to the corresponding touch electrode blocks 13 at the external of the third side 103 of the display region 10 (i.e. in the third non-display region of the display region 10).

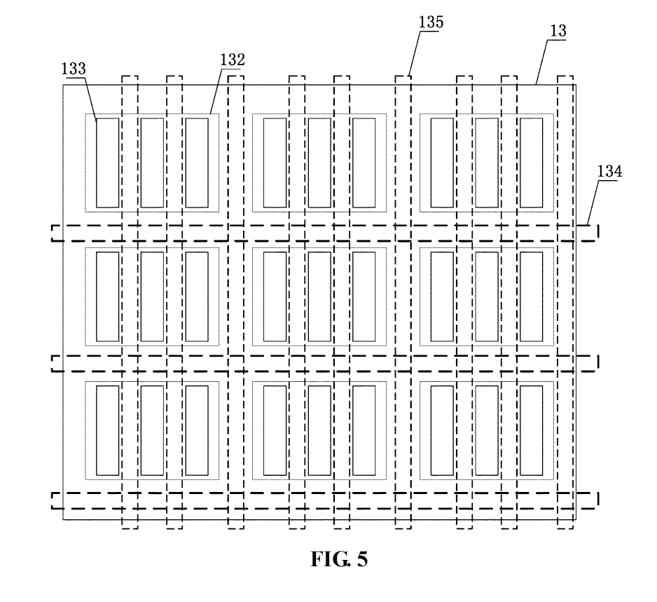

FIG. 5 is a schematic top view of the touch electrode block in FIG. 4. The touch electrode block 13 corresponds to a plurality of pixel cells 132. In the present embodiment, illustratively, a touch electrode block 13 corresponds to the pixel cells 132 in a three rows by three columns pattern. Each of the pixel units 132 includes three sub-pixels 133. It is understood that the three sub-pixels 133 may be of different colors. For example, each of the pixel units 132 can include a red sub-pixel, a green sub-pixel and a blue sub-pixel. The touch electrode block 13 corresponds to three first wiring regions 134 extending along the row direction. The wirings such as the gate lines may be provided in the first wiring regions 134, and corresponds to nine second wiring regions 135 extending along the column direction, where the wirings such as the data lines may be provided in the second wiring regions 135. Referring to FIG. 4, in the case that the number of the touch signal lines 14 corresponding to the touch electrode block 13 is greater than the number of the first wiring regions 134, the sub-pixels 133 may be blocked by the touch signal lines 14, thus affecting the display effect. In view of this, the following embodiments of the present disclosure are provided.

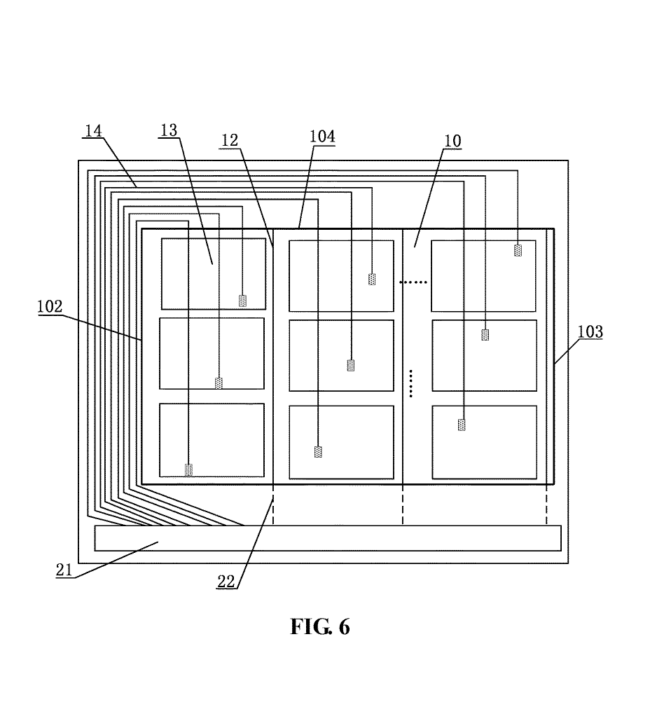

Illustratively, with reference to FIG. 6, a plurality of touch signal lines 14 may also be extended to the external of the fourth side 104 of the display region 10 (i.e. a plurality of touch signal lines 14 may also be extended to a fourth non-display region of the display region 10), and electrically connected to the touch electrode block 13 corresponding to the display region 10 at the external of the fourth side 104 of the display region 10 (i.e. in the fourth non-display region of the display region 10). Referring to FIGS. 5 and 6, the number of the second wiring regions 135 extending along the column direction is greater than the number of the first wiring regions 134 extending along the row direction. In this case, the touch signal lines 14 may be provided in the second wiring regions 135, in order to extend to the external of the fourth side 104 of the display region 10 along the column direction. Thus, the array substrate not only prevents the first connection lines 22 from being interfered by the touch signal lines 14 due to the increased capacitance between the touch signal lines 14 and the first connection lines 22, but also prevents the touch signal lines 14 from being overlapped with the sub-pixels 133. It is noted that, in the case that each of the touch signal drive lines 14 is extended from the driver chip 21 to the external of the third side 103 of the display region 10 (i.e. the third non-display region of the display region 10), the touch signal lines 14 may also be extended to the external of the fourth side 104 of the display region 10 and electrically connected to the corresponding touch electrode block 13 at the external of the fourth side 104 of the display region 10.

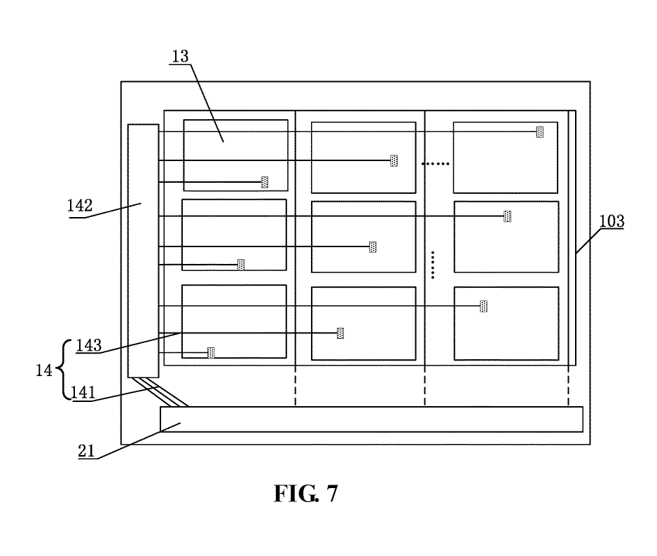

Illustratively, with reference to FIG. 7, the array substrate further includes a switching circuit 142, the touch signal line 14 includes a plurality of touch wirings 143 and a plurality of second connection lines 141, each of the plurality of touch wirings 143 is electrically connected to the corresponding touch electrode block 13, and each of the second connection lines 141 is electrically connected to N touch wirings 143 of the touch wirings through the switching circuit 142, where N is an integer greater than or equal to 1, and the second connection lines 141 are further electrically connected to the driver chip 21, the switching circuit 142 is configured to transmit the touch signal transmitted by each of the second connection lines 141 to the touch electrode block 13 electrically connected to the N touch wirings 143 corresponding to the second connection line 141. In such an arrangement, the number of the second connection lines 141 is equal to or less than the number of touch wirings 143, to reduce the area occupied by the second connection lines 141, thereby reducing the size of frames of the array substrate. The array substrate can be applied to any large-size product, such as a product with 15 inches.

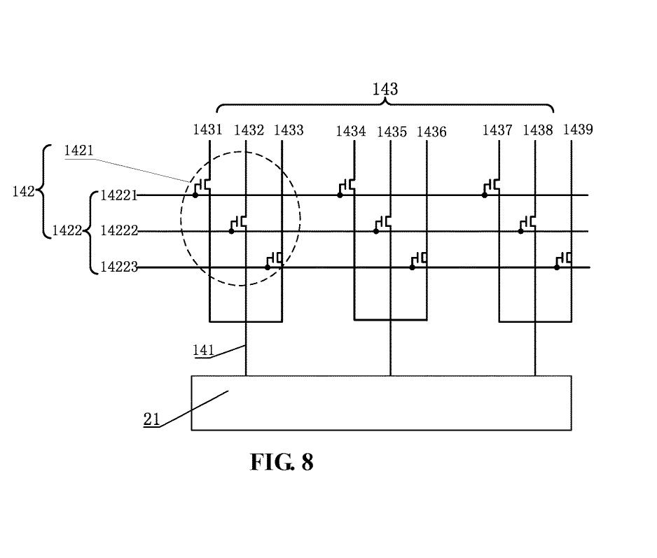

Illustratively, in combination with FIGS. 7 and 8, the switching circuit 142 comprises a plurality of thin film transistor groups 1421 and a plurality of control lines 1422, where each of the thin film transistor groups 1421 includes N thin film transistors, control terminals of the N thin film transistors of each of the thin film transistor groups are electrically connected to the different control lines 1422, respectively, input terminals of the N thin film transistors of each of the thin film transistor groups 1421 are electrically connected to one of the second connection lines 141, output terminals of the N thin film transistors of each of the thin film transistor groups 1421 are electrically connected to the corresponding touch wirings 143 where N is an integer greater than or equal to 1. Alternatively, the number of the thin film transistor in the switching circuit 142 may be same as the number of the touch electrode block 13 in the array substrate.

As shown in FIG. 8, illustratively, each of the thin film transistor groups 1421 includes three thin film transistors. The operating principal of the switching circuit 142 is as follows: if the control line 14221 is turned on, the respective touch electrode blocks electrically connected to the touch wiring 1431, the touch wiring 1434 and the touch wiring 1437 are detected; if the control line 14222 is turned on, the respective touch electrode blocks electrically connected to the touch wiring 1432, the touch wiring 1435 and the touch wiring 1438 are detected and so on, so as to achieve connection and detection of each of the touch electrode blocks.

In combination with Figures and 8, the number of control lines 1422 in the switching circuit 142 may be same as the number of the thin film transistors in one of the thin film transistor groups 1421. In this embodiment, the number of the control lines 1422 in the switching circuit 142 is not limited. Alternatively, the number of the control lines 1422 included in the switching circuit 142 is equal to the number of the touch electrode block 13 on the array substrate along the row direction, where the row direction refers to the direction of extending from the second side 102 to the third side 103 of the display region 10 or the direction of extending from the third side 103 to the second side 102 of the display region 10.

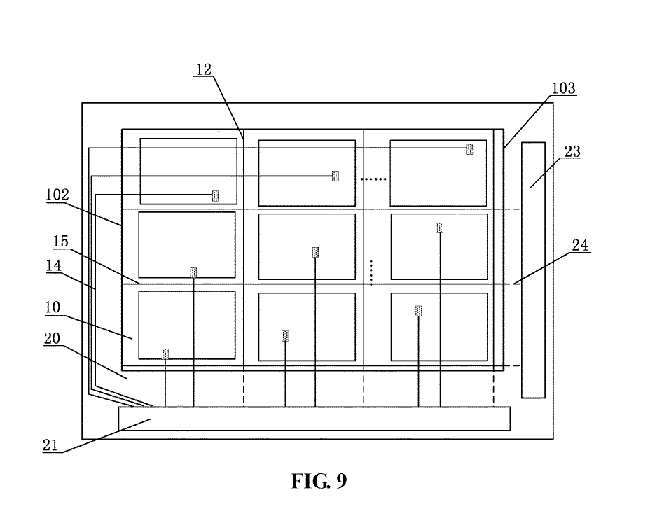

As shown in FIG. 9, in the array substrate provided by the above embodiment, the non-display region 20 may further include a gate driver circuit 23, the display region 10 may also include a plurality of scan lines 15, the scan lines 15 and the data lines 12 are crossed over each other, and the plurality of scan lines 15 are electrically connected to the gate driver circuit 23 via the plurality of third connection lines 24, respectively. If the gate driver circuit 23 is provided at the external of the third side 103 of the display region 10 (i.e. in the third non-display region of the display region 10), at least one of the touch signal lines 14 is extended from the driver chip 21 to the external of the second side 102 of the display region 10. It is noted that, if the gate driver circuit 23 is provided at the external of the second side 102 of the display region 10, at least one of the touch signal lines 14 is extended from the driver chip 21 to the external of the third side 103 of the display region 10. That is, the touch signal line 14 and the gate driver circuit 23 are disposed opposite to each other. And, in combination with FIGS. 8 and 9, the control line 1422 in the switching circuit 142 may be connected to the gate driver circuit 23, i.e., the gate driver circuit 23 can provides the control signal of the switching circuit 142.

Embodiments provide a touch display panel. The touch display panel includes an array substrate. The array substrate uses the array substrate according to the present invention.

Embodiments provide a touch display device. The touch display device includes a touch display panel. The touch display panel uses the touch display panel according to the present disclosure. The touch display device may be a mobile phone, television, computers and other devices having any touch and display functions.

It is noted that the preferable embodiments and the applied technology principles of the present disclosure are merely described as above. It should be understood for those skilled in the art that the present disclosure is not limited to particular embodiments described herein. Various apparent changes, readjustment and alternative can be made by those skilled in the art without departing the scope of protection of the present disclosure. Therefore, although the present disclosure is illustrated in detail through the above embodiments, the present disclosure is not merely limited to the above embodiments, and can further include more of other equivalent embodiments without departing the conception of the present disclosure. The scope of the present disclosure is subject to the appended claims.

1. An array substrate, comprising:
a substrate; and
a display region and a non-display region surrounding the display region, wherein a driver is provided in the non-display region; and, wherein
the display region comprises:
a plurality of data lines, wherein each of the plurality of data lines is electrically connected to the driver chip via a respective one of a plurality of first connection lines; and
a plurality of touch electrode blocks, wherein the plurality of touch electrode blocks are electrically connected to the driver chip via a plurality of touch signal lines; and
in the non-display region, the plurality of touch signal lines are not overlapped with the plurality of first connection lines in a direction perpendicular to the substrate.

2. The array substrate of claim 1, wherein
the display region is rectangular, and the driver chip is provided in a first non-display region corresponding to a first side of the display region; and
at least one of the touch signal lines is extended from the driver chip to a second non-display region corresponding to a second side and/or a third non-display region corresponding to a third side of the display region, to electrically connect to at least one of the touch electrode blocks in the display region, wherein the second side and the third side of the display region are disposed opposite to each other.

3. The array substrate of claim 2, wherein
each of the touch signal lines is extended from the driver chip to the second non-display region and/or the third non-display region.

4. The array substrate of claim 2, wherein
in the first non-display region, each of the touch signal lines does not overlap with the plurality of first connection lines in the direction perpendicular to the substrate.

5. The array substrate of claim 2, wherein
the plurality of touch signal lines are extended across the second side or the third side of the display region and electrically connected to the corresponding touch electrode blocks.

6. The array substrate of claim 2, wherein
the plurality of touch signal lines are further extended to a forth non-display region corresponding to a fourth side of the display region, extended across the fourth side of the display region, and electrically connected to the corresponding touch electrode blocks, wherein the fourth side and the first side of the display region are disposed opposite to each other.

7. The array substrate of claim 1, further comprising a switching circuit, wherein
the touch signal lines comprises a plurality of touch wirings and a plurality of second connection lines, wherein each of the touch wirings is electrically connected to a respective one of the plurality of touch electrode blocks, each of the second connection lines is electrically connected to N touch wirings of the touch wirings through the switching circuit, the second connection lines are further electrically connected to the driver chip, the switching circuit is configured to transmit a touch signal transmitted by each of the second connection lines to the corresponding N touch wirings, N being an integer greater than or equal to 1.

8. The array substrate of claim 7, wherein
the switching circuit comprises a plurality of thin film transistor groups and a plurality of control lines, wherein each of the thin film transistor groups comprises N thin film transistors, control terminals of the N thin film transistors of each of the thin film transistor groups being electrically connected to the different control lines, respectively; input terminals of the N thin film transistors of each of the thin film transistor groups are electrically connected to one of the second connection lines; and output terminals of the N thin film transistors of each of the thin film transistor groups are electrically connected to the corresponding touch wirings, respectively.

9. The array substrate of claim 1, further comprising a common electrode layer, wherein
the common electrode layer comprises a plurality of electrodes blocks insulated from each other, wherein the electrode blocks are uniformly arranged in an matrix pattern, and the electrode blocks are multiplexed as the touch electrode blocks.

10. A touch display panel, comprising the array substrate according to any one of claim 1.

11. A touch display device, comprising the touch display panel according to claim 10.
